(19) United States
(12) Patent Application Publication
(10) Pub. No.: US 2024/0175771 A1
(43) Pub. Date: May 30, 2024

(54) METHOD AND DEVICE FOR PROVIDING WIRE BREAKAGE WARNING

(71) Applicant: GlobalWafers Co., Ltd., Hsinchu (TW)

(72) Inventors: Chien-Wen YU, Hsinchu (TW); Shang-Chi Wang, Hsinchu (TW); Bo-Ting Lin, Hsinchu (TW)

(73) Assignee: GlobalWafers Co., Ltd., Hsinchu (TW)

(21) Appl. No.: 18/071,631

(22) Filed: Nov. 30, 2022

(51) Int. Cl. G01L 5/04; B28D 5/04; G01L 5/00

(52) U.S. Cl. CPC G01L 5/04; B28D 5/045; G01L 5/0061

(57) ABSTRACT

Embodiments of the disclosure provide a method and device for providing a wire breakage warning. The method includes: obtaining a plurality of process values when a crystal ingot cutting machine uses a cutting wire to cut a crystal ingot; dividing the process values into N groups, and determining a statistical property of each of the groups; identifying outlier values in the process values based on the statistical property of each of the groups, or determining a statistical property variation corresponding to each of the groups based on the statistical property of each of the groups; and in response to determining that the outlier values in the process values meet a first warning condition, or the statistical property variation corresponding to each of the groups meets a second warning condition, providing a wire breakage warning associated with the cutting wire.

### BACKGROUND OF THE INVENTION

### Field of the Invention

The invention relates to a technique for monitoring a crystal ingot process, and more particularly, to a method and device for providing a wire breakage warning.

### Description of Related Art

In the prior art, after the manufacture of a crystal ingot is completed, the crystal ingot may be further cut into a chip by a crystal ingot cutting machine. In general, the crystal ingot cutting machine may cut the crystal ingot via a cutting wire, such as a wire mesh.

However, in the process that the cutting wire is used to cut the crystal ingot, the cutting wire may be broken due to some reasons, thus accordingly affecting the cutting result of the crystal ingot.

Therefore, for those skilled in the art, if it is possible to predict whether the cutting wire is about to be broken, it should be possible to effectively avoid the accidental breakage of the cutting wire affecting the cutting process of the crystal ingot.

### SUMMARY OF THE INVENTION

Accordingly, the invention provides a method and device for providing a wire breakage warning that may be used to solve the above technical issues.

An embodiment of the invention provides a method for providing a wire breakage warning, including: obtaining a plurality of process values when a crystal ingot cutting machine uses a cutting wire to cut a crystal ingot; dividing the plurality of process values into N groups, and determining a statistical property of each of the groups, wherein N is a positive integer; identifying at least one outlier value in the plurality of process values based on the statistical property of each of the groups, or determining a statistical property variation corresponding to each of the groups based on the statistical property of each of the groups; and providing a wire breakage warning associated with the cutting wire in response to determining that the at least one outlier value in the plurality of process values meets a first warning condition, or the statistical property variation corresponding to each of the groups meets a second warning condition.

An embodiment of the invention provides a device for providing a wire breakage warning, including a storage circuit and a processor. The storage circuit stores a program code. The processor is coupled to the storage circuit and accesses the program code to execute: obtaining a plurality of process values when a crystal ingot cutting machine uses a cutting wire to cut a crystal ingot; dividing the plurality of process values into N groups, and determining a statistical property of each of the groups, wherein N is a positive integer; identifying at least one outlier value in the plurality of process values based on the statistical property of each of the groups, or determining a statistical property variation corresponding to each of the groups based on the statistical property of each of the groups; and providing a wire breakage warning associated with the cutting wire in response to determining that the at least one outlier value in the plurality of process values meets a first warning condition, or the statistical property variation corresponding to each of the groups meets a second warning condition.

### BRIEF DESCRIPTION OF THE DRAWINGS

FIG. 1 is a schematic diagram of a crystal ingot cutting machine shown according to an embodiment of the invention.

FIG. 2 is a schematic diagram of a device for providing a wire breakage warning shown according to an embodiment of the invention.

FIG. 3 is a flowchart of a method for providing a wire breakage warning shown according to an embodiment of the invention.

FIG. 4 is a flowchart of determining outlier values in the i-th group shown according to the first embodiment of the invention.

FIG. 5A is a schematic diagram of a box-and-whisker plot corresponding to one group shown according to an embodiment of the invention.

FIG. 5B is a schematic diagram of determining extreme outlier values and moderate outlier values shown according to an embodiment of the invention.

FIG. 6A is a schematic diagram of a box-and-whisker plot corresponding to each group shown according to an embodiment of the invention.

FIG. 6B is a schematic diagram of a box-and-whisker plot corresponding to each group shown according to another embodiment of the invention.

### DESCRIPTION OF THE EMBODIMENTS

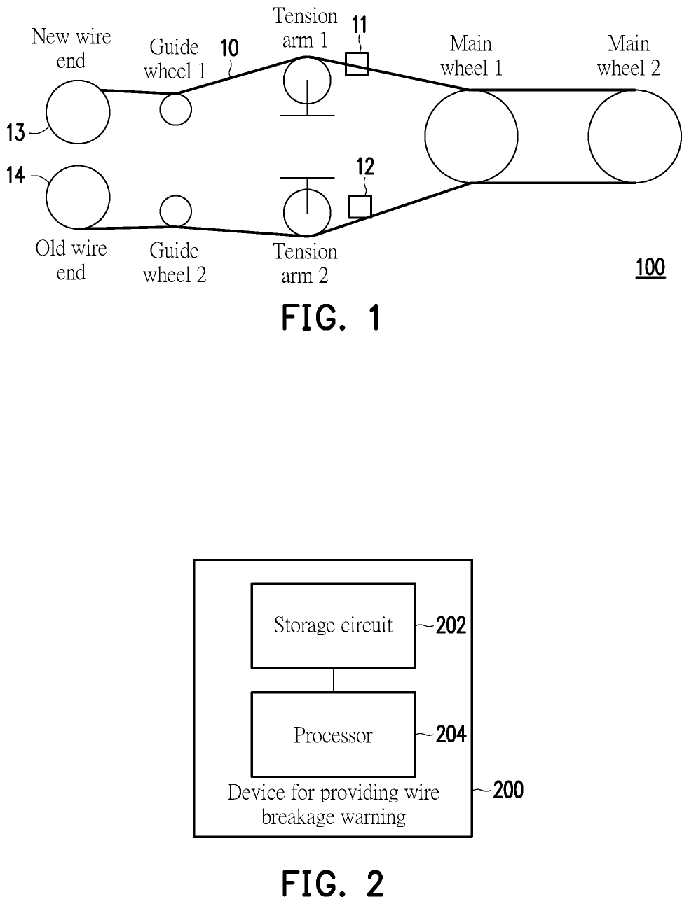

FIG. 1 is a schematic diagram of a crystal ingot cutting machine shown according to an embodiment of the invention. In FIG. 1, a crystal ingot cutting machine 100, for example, may include the various elements shown. In the present embodiment, a cutting wire 10 may be guided from a new wire end 13 to an old wire end 14 via a guide wheel 1, a tension arm 1, a main wheel 1, a main wheel 2, a tension arm 2, and a guide wheel 2 in sequence. Moreover, the crystal ingot cutting machine 100 may have tension sensors 11 and 12 that may be disposed near the tension arm 1 and the tension arm 2 respectively to detect the tension of the cutting wire 10.

In the process of cutting a certain crystal ingot (hereinafter referred to as a crystal ingot A) by the cutting wire 10, the crystal ingot cutting machine 100 is generally set to cut the crystal ingot A with a certain tension. If the tension values measured by the tension sensors 11 and 12 do not match the desired tension, the crystal ingot cutting machine 100 may adjust the position/angle of the tension arm 1 and/or the tension arm 2 to tighten or relax the cutting wire 10, so as to achieve the object of adjusting the tension of the cutting wire 10.

However, as described above, in the process that the cutting wire 10 is used to cut the crystal ingot A, if the cutting wire 10 is broken, the crystal ingot A may not be properly cut, thereby affecting the cutting effect.

Accordingly, the invention provides a method and device for providing a breakage warning that may be used to provide a breakage warning associated with the cutting wire 10. Therefore, the operator of the crystal ingot cutting machine 100 may adjust the operating situation of the crystal ingot cutting machine 100 accordingly, so as to prevent the cutting effect of the crystal ingot A from being affected due to the unexpected breakage of the cutting wire 10. Description is further provided below.

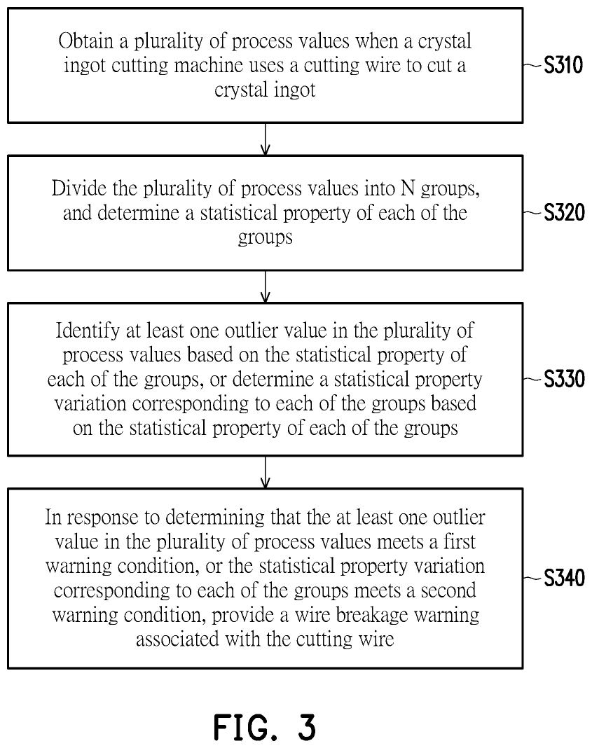

FIG. 2 is a schematic diagram of a device for providing a wire breakage warning shown according to an embodiment of the invention. In FIG. 2, a device 200 for providing a breakage warning may be implemented as various smart devices and/or computer devices. In some embodiments, the device 200 for providing the breakage warning may also be integrated into the crystal ingot cutting machine 10 in the form of a module, but the invention may be not limited thereto.

In the present embodiment, the device 200 for providing the breakage warning includes a storage circuit 202 and a processor 204. The storage circuit 202 is, for example, any type of fixed or removable random-access memory (RAM), read-only memory (ROM), flash memory, hard disk, or other similar devices or a combination of these devices, and may be used to record a plurality of program codes or modules.

The processor 204 is coupled to the storage circuit 202 and may be a general-purpose processor, a special-purpose processor, a conventional processor, a digital signal processor, a plurality of microprocessors, one or a plurality of microprocessors combining digital signal processor cores, a controller, a microcontroller, an application-specific integrated circuit (ASIC), a field-programmable gate array (FPGA), any other types of integrated circuits, a state machine, a processor based on advanced RISC machine (ARM), and a similar product thereof.

In an embodiment of the invention, the processor 204 may access the modules and program codes recorded in the storage circuit 202 to implement the method for providing a breakage warning proposed by the invention. The details are as follows.

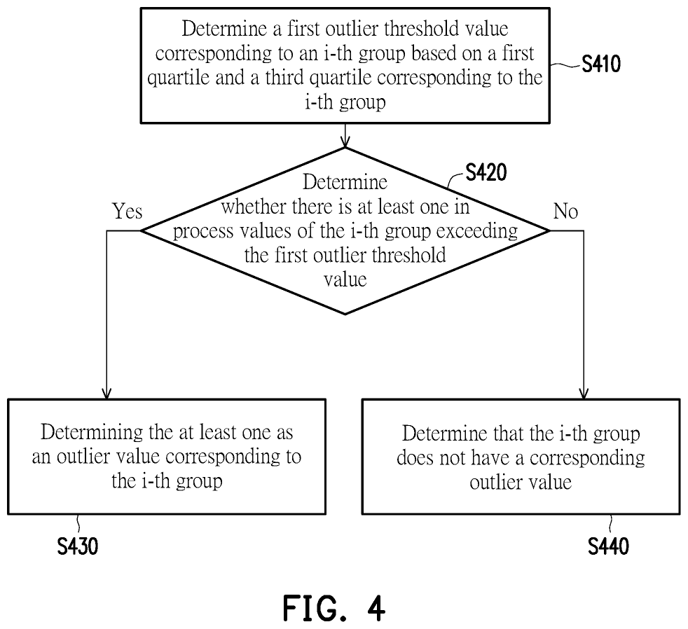

FIG. 3 is a flowchart of a method for providing a breakage warning shown according to an embodiment of the invention. The method of the present embodiment may be executed by the device 200 for providing a breakage warning of FIG. 2. The following describes the details of each step of FIG. 3 with the elements shown in FIG. 1 and FIG. 2.

First, in step S310, the processor 204 obtains a plurality of process values when the crystal ingot cutting machine 100 uses the cutting wire 10 to cut the crystal ingot A.

For ease of explanation, in the following embodiments, it is assumed that the considered process values are a plurality of tension values measured from the cutting wire 10, which may be measured by the tension sensor 11 and/or the tension sensor 12, but the invention may be not limited thereto. In other embodiments, the process values considered in the invention may also be other types of process values, and are not limited to the tension values measured from the cutting wire 10.

In step S320, the processor 204 divides the plurality of process values into N groups (N is a positive integer), and determines the statistical property of each of the groups.

Next, in step S330, the processor 204 identifies at least one outlier value in the plurality of process values based on the statistical property of each of the groups, or determines the statistical property variation corresponding to each of the groups based on the statistical property of each of the groups.

To facilitate understanding, the details of finding outlier values in step S330 and the details of determining statistical property variation of each of the groups are described below with the first embodiment and the second embodiment, respectively.

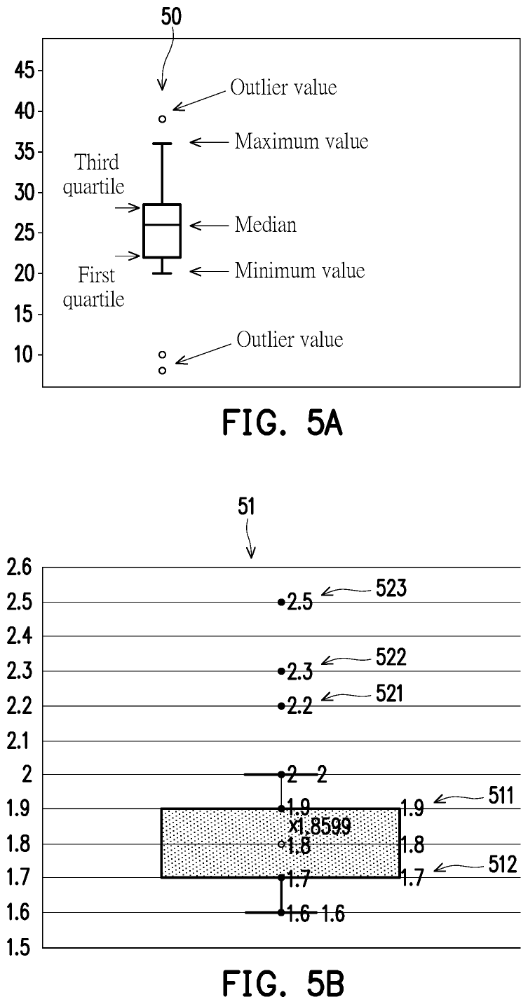

In the first embodiment, the statistical property of each of the groups is, for example, the first quartile and the third quartile of the process values (e.g., tension values) of each of the groups. Accordingly, for the i-th group (1≤i≤N) in the N groups, the processor 204 may execute the mechanism of FIG. 4 to determine the outlier values in the i-th group.

FIG. 4 is a flowchart of determining outlier values in the i-th group shown according to the first embodiment of the invention. First, in step S410, the processor 204 may determine a first outlier threshold value corresponding to the i-th group based on the first quartile and the third quartile corresponding to the i-th group.

In the process of executing step S410, the processor 204 may, for example, execute: obtaining a difference between the first quartile and the third quartile corresponding to the i-th group, and determining a first factor; obtaining a first product of the difference and the first factor, and summing the first product with the third quartile corresponding to the i-th group as the first outlier threshold value.

For example, if the third quartile of the i-th group is 1.9 and the first quartile is 1.7, the processor 204 may obtain the difference between the two as 0.2.

In the first embodiment, the determined outlier values may be substantially divided into two types: moderate outlier values and extreme outlier values, and the processor 204 may determine the first factor according to the type of outlier values to be determined.

In an embodiment, assuming that the outlier value to be determined by the processor 204 is a moderate outlier value, the processor 204 may, for example, determine that the first factor is a value between 0.1 and 2 (e.g., 1.5).

In this case, the processor 204 may obtain the first product (e.g., 0.2*1.5) of the difference (e.g., 0.2) and the first factor (e.g., 1.5), and then sum the first product with the third quartile of the i-th group (e.g., 1.9) to form the first outlier threshold value (e.g., 2.2). In this case, the obtained first outlier threshold value may be referred to as a moderate outlier threshold value corresponding to the i-th group, but the invention may be not limited thereto.

In another embodiment, assuming that the outlier value to be determined by the processor 204 is an extreme outlier value, the processor 204 may, for example, determine that the first factor is a value between 2 and 5 (e.g., 3).

In this case, the processor 204 may obtain the first product (e.g., 0.2*3) of the difference (e.g., 0.2) and the first factor (e.g., 3), and then sum the first product with the third quartile of the i-th group (e.g., 1.9) to form the first outlier threshold value (e.g., 2.5). In this case, the obtained first outlier threshold value may be referred to as an extreme outlier threshold value corresponding to the i-th group, but the invention may be not limited thereto.

In the first embodiment, the processor 204 may determine the moderate outlier threshold value and/or the extreme outlier threshold value corresponding to the i-th group according to the designer's requirements. Moreover, if an outlier value is not less than the extreme outlier value (that is, exceeding the moderate outlier value), the outlier value is determined as an extreme outlier value and not determined as a moderate outlier value.

After determining the first outlier threshold value (e.g., moderate outlier threshold value and/or extreme outlier threshold value) corresponding to the i-th group, in step S420, the processor 204 may determine whether there is at least one in the process values of the i-th group exceeding the first outlier threshold value.

If so, the processor 204 may execute step S430 to determine the at least one as an outlier value corresponding to the i-th group. If not, the processor 204 may determine that the i-th group does not have a corresponding outlier value in step S440.

In an embodiment, if the considered first outlier threshold value is a moderate outlier threshold value, the outlier value corresponding to the i-th group determined by the processor 204 in step S430 may be understood as a moderate outlier value in the i-th group. In another embodiment, if the considered first outlier threshold value is an extreme outlier threshold value, the outlier value corresponding to the i-th group determined by the processor 204 in step S430 may be understood as an extreme outlier value in the i-th group.

In the first embodiment, the processor 204 may determine the moderate outlier value and/or the extreme outlier value corresponding to the i-th group as the outlier value identified in step S320 according to the designer's requirements, but the invention may be not limited thereto.

In the second embodiment, when it is determined that the statistical property corresponding to the (j+1)-th group in the N groups is changed, for example, the processor 204 may obtain the difference between the statistical property of the (j+1)-th group and the statistical property of the j-th group in the N groups as the statistical property variation corresponding to the (j+1)-th group.

In the second embodiment, the statistical property of each of the groups includes, for example, the third quartile of the process values of each of the groups, but the invention may be not limited thereto.

To facilitate understanding, in the following, it is assumed that the processor 204 obtains a total of 20000 consecutive tension values in step S310, and the processor 204 may divide the tension values into 20 groups in step S320 (i.e., N is 20). In this case, each of the groups includes 1000 consecutive tension values that are only used as an example, and not intended to limit possible implementations of the invention.

In an embodiment, various statistical properties of each of the groups of process values (e.g., tension values) may be plotted as corresponding box-and-whisker plots to facilitate observation.

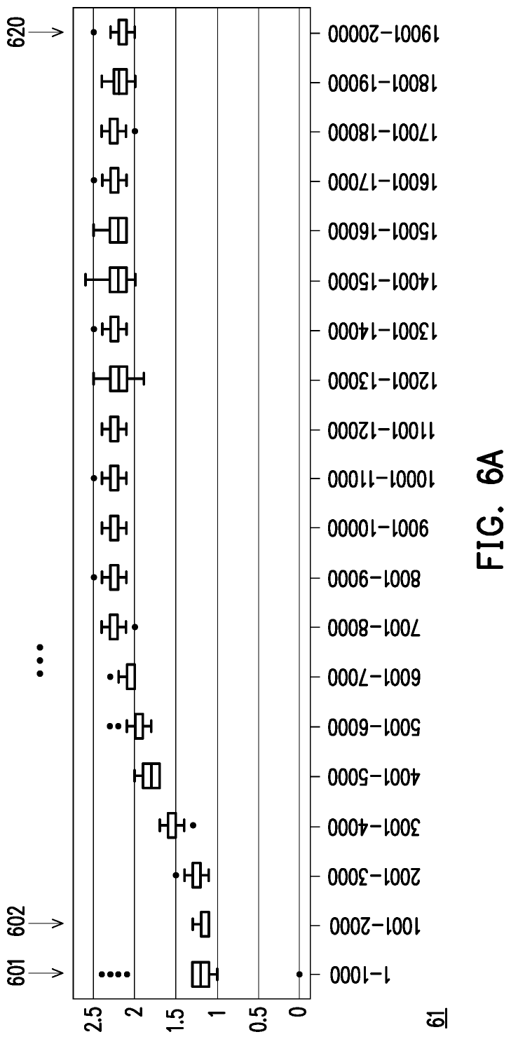

FIG. 5A is a schematic diagram of a box-and-whisker plot corresponding to one group shown according to an embodiment of the invention. In an embodiment, after the tension values of a certain group are obtained, the processor 204 may, for example, accordingly obtain the statistical properties of the outlier values (including moderate outliers and/or extreme outliers), maximum value, third quartile, median, first quartile, and minimum value of tension values in the group, and accordingly draw the corresponding box-and-whisker plot, such as a box-and-whisker plot 50 in FIG. 5A, but the invention may be not limited thereto.

FIG. 5B is a schematic diagram of determining extreme outlier values and moderate outlier values shown according to an embodiment of the invention. In FIG. 5B, it is assumed that a box-and-whisker plot 51 shown corresponds to the i-th group mentioned in the above embodiment. As previously stated, a third quartile 511 of the i-th group is 1.9, a first quartile 512 is 1.7, and the processor 204 may obtain the difference between the two as 0.2.

Then, if the processor 204 is to determine the moderate outlier threshold value, the processor 204 may, for example, determine that the first factor is 1.5. In this case, the processor 204 may calculate the moderate outlier threshold as 2.2 (i.e., 1.9+0.2*1.5), but the invention may be not limited thereto.

Moreover, if the processor 204 is to determine the extreme outlier threshold value, the processor 204 may, for example, determine that the first factor is 3. In this case, the processor 204 may calculate the extreme outlier threshold as 2.5 (i.e., 1.9+0.2*3), but the invention may be not limited thereto.

Accordingly, it may be seen from FIG. 5B that outlier values 521 and 522 are, for example, moderate outlier values, and an outlier value 523 is, for example, an extreme outlier value, but the invention may be not limited thereto.

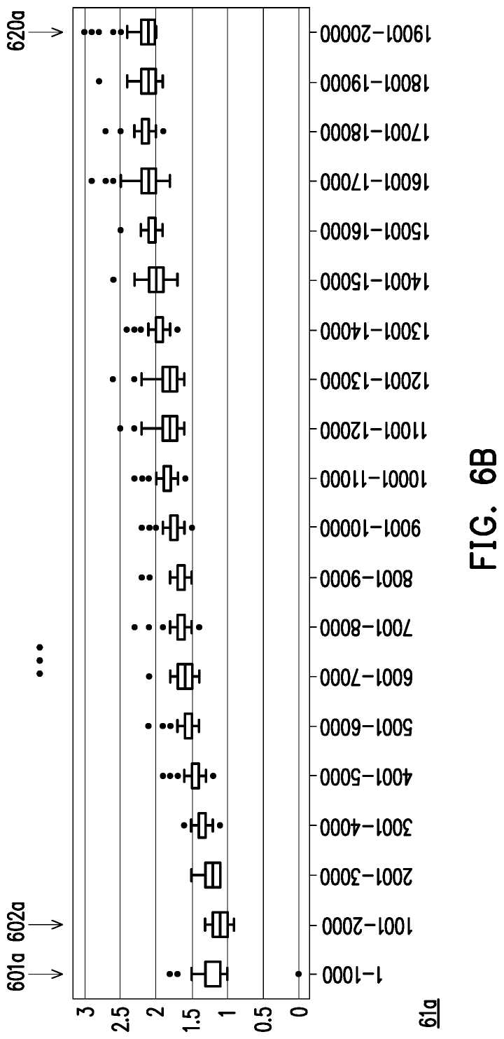

FIG. 6A is a schematic diagram of a box-and-whisker plot corresponding to each of the groups shown according to an embodiment of the invention. In the context of FIG. 6A, the 20000 tension values considered may be measured by, for example, the tension sensor 11 of FIG. 1.

In the present embodiment, a box-and-whisker plot 61 includes box-and-whisker plots 601, 602 . . . 620 respectively corresponding to the 1st group (including the 1st tension value to the 1000th tension value), the 2nd group (including the 1001th tension value to the 2000th tension value) . . . the 20th group (including the 19001th tension value to the 20000th tension value) in the 20 groups.

FIG. 6B is a schematic diagram of a box-and-whisker plot corresponding to each of the groups shown according to another embodiment of the invention. In the context of FIG. 6B, the 20000 tension values considered may be measured by, for example, the tension sensor 12 of FIG. 1.

In the present embodiment, a box-and-whisker plot 61a includes box-and-whisker plots 601a, 602a . . . 620a respectively corresponding to the 1st group (including the 1st tension value to the 1000th tension value), the 2nd group (including the 1001th tension value to the 2000th tension value) . . . the 20th group (including the 19001th tension value to the 20000th tension value) in the 20 groups.

For the convenience of description, the following assumes that the total number of obtained process values (e.g., tension values) is 20000, but the invention may be not limited thereto.

After the outlier values of each of the groups are identified and/or the statistical property variation of each of the groups is determined, in step S340, the processor 204 provides a breakage warning associated with the cutting wire 10 in response to determining that an outlier value in the plurality of process values meets a first warning condition, or the statistical property variation corresponding to each of the groups meets a second warning condition.

In the first embodiment, the processor 204 may determine a plurality of first group sets in the groups, wherein each of the first group sets includes consecutive k groups in the groups, wherein k is an integer and 1≤k≤N.

Next, in response to determining that a number sum of the outlier values corresponding to the groups in any of the first group sets is not less than a first number, the processor 204 may determine that the outlier values in the process values meet the first warning condition. Moreover, in response to determining that the number sum of the outlier values corresponding to the groups in any of the first group sets is less than a first number, the processor 204 may determine that the outlier values in the process values do not meet the first warning condition.

In different implementations of the first embodiment, the k value may adopt different values according to the needs of the designer, so as to derive different determination processes. Description is further provided below.

In the first implementation of the first embodiment, the outlier values in each of the groups are, for example, moderate outlier values. Assuming the designer sets the principle that in all process values (i.e., tension values), if there is not less than one moderate outlier value in 16% or more of consecutive data (that is, the first number is assumed to be 1), it is determined that the first warning condition is met. In this case, the processor 204 may obtain, for example, 16% of the total number of process values (i.e., 3200), and then round 3200 to 4000 based on the number (i.e., 1000) of process values in each of the groups. Accordingly, the processor 204 may determine k as 4 based on 4000 (corresponding to the sum of the process values in the 4 groups), but the invention may be not limited thereto.

After k is determined, the processor 204 may, for example, determine the plurality of first group sets accordingly. In an embodiment, the m-th first group set in the plurality of first group sets may include the m-th group to the (m+k−1)-th group in the N groups, 1≤m≤(N−k+1), but the invention may be not limited thereto. That is, each of the first group sets includes k groups in the N groups, and each of the first group sets has different group members, but the invention may be not limited thereto.

For example, in the case that k is 4 and N is 20, the m-th first group set in the plurality of first group sets may include the m-th group to the (m+k−1)-th group in the N groups, 1≤m≤17, but the invention may be not limited thereto. That is, each of the first group sets includes 4 groups in the N groups, and each of the first group sets has different group members, but the invention may be not limited thereto.

Accordingly, the processor 204 may determine whether there is not less than one moderate outlier value (i.e., the first number is assumed to be 1) in any one of the first group sets. If the number sum of moderate outlier values in the groups in any first group set is not less than the first number (e.g., 1), the processor 204 may determine that the outlier values in the process values meet the first warning condition, and provide a breakage warning accordingly. Moreover, if the number sum of moderate outlier values of the groups in each of the first group sets is less than the first number (e.g., 1), the processor 204 may determine that the outlier values in the process values do not meet the first warning condition.

In short, in the case that k is 4 and the first number is 1, if there is not less than one moderate outlier value in the 4000 process values corresponding to 4 consecutive box-and-whisker plots, the processor 204 may determine that the first warning condition is met, and provide a corresponding breakage warning, but the invention may be not limited thereto.

In the second implementation of the first embodiment, the outlier values in each of the groups are, for example, extreme outlier values. It is assumed that the principle set by the designer is that in the process values (i.e., tension values) of a single group, if there is an extreme outlier value of not less than 0.5%, it is determined that the first warning condition is met. In this case, the processor 204 may obtain, for example, 0.5% (i.e., 5) of the total number of process values of a single group as the first number. Moreover, since the determination principle designed by the designer takes a single group as the determination object, the processor 204 may determine that k is 1.

After k is determined, the processor 204 may, for example, determine the plurality of first group sets accordingly. In the case that k is 1, the plurality of first group sets may be the N groups, respectively. That is, each of the first group sets includes one of the N groups, but the invention may be not limited thereto.

Accordingly, the processor 204 may determine whether there are not less than five extreme outlier values (i.e., the first number is assumed to be 5) in any one of the first group sets. If the number sum of extreme outlier values in the groups in any first group set is not less than the first number (e.g., 5), the processor 204 may determine that the outlier values in the process values meet the first warning condition, and provide a breakage warning accordingly. Moreover, if the number sum of extreme outlier values of the groups in each of the first group sets is less than the first number (e.g., 5), the processor 204 may determine that the outlier values in the process values do not meet the first warning condition.

In short, in the case that k is 1 and the first number is 5, if there are not less than five extreme outlier values in the 1000 process values of any one box-and-whisker plot, the processor 204 may determine that the first warning condition is met, and provide a corresponding breakage warning, but the invention may be not limited thereto.

In the third implementation of the first embodiment, the outlier values in each of the groups are, for example, extreme outlier values. Assuming the designer sets the principle that in all process values (i.e., tension values), if the proportion of extreme outlier values of 10% or more consecutive data is not less than 0.06% (i.e., the first number is assumed to be 20000*10%*0.06%), it is determined that the first warning condition is met.

In this case, the processor 204 may obtain, for example, 10% (i.e., 2000) of the total number of process values, and determine k as 2 accordingly, but the invention may be not limited thereto. In addition, since 0.06% of 2000 is 1.2, the processor 204 may round up 1.2 to 2 as the first number considered in the third embodiment, but the invention may be not limited thereto.

After k is determined, the processor 204 may, for example, determine the plurality of first group sets accordingly. In an embodiment, the m-th first group set in the plurality of first group sets may include the m-th group to the (m+k−1)-th group in the N groups, 1≤m≤(N−k+1), but the invention may be not limited thereto. That is, each of the first group sets includes k groups in the N groups, and each of the first group sets has different group members, but the invention may be not limited thereto.

For example, in the case that k is 2 and N is 20, the m-th first group set in the plurality of first group sets may include the m-th group to the (m+1)-th group in the N groups, 1≤m≤19, but the invention may be not limited thereto. That is, each of the first group sets includes 2 groups in the 20 groups, and each of the first group sets has different group members, but the invention may be not limited thereto.

Accordingly, the processor 204 may determine whether there are not less than two extreme outlier values (i.e., the first number is assumed to be 2) in any one of the first group sets. If the number sum of extreme outlier values in the groups in any first group set is not less than the first number (e.g., 2), the processor 204 may determine that the outlier values in the process values meet the first warning condition, and provide a breakage warning accordingly. Moreover, if the number sum of extreme outlier values of the groups in each of the first group sets is less than the first number (e.g., 2), the processor 204 may determine that the outlier values in the process values do not meet the first warning condition.

In short, in the case that k is 2 and the first number is 2, if there are not less than two extreme outlier values in the 2000 process values corresponding to 2 consecutive box-and-whisker plots, the processor 204 may determine that the first warning condition is met, and provide a corresponding breakage warning, but the invention may be not limited thereto.

In an embodiment of the invention, the processor 204 may simultaneously execute the determination operations of one or a plurality in the first embodiment to the third embodiment. If the processor 204 determines that the process values in any of the first embodiment to third embodiment are determined to meet the first warning condition, the processor 204 may provide a corresponding breakage warning, but the invention may be not limited thereto.

In an embodiment, the number of moderate outlier values and the number of extreme outlier values of each of the box-and-whisker plots in FIG. 6B may be, for example, sorted into the contents of Table 1 below.

TABLE 1

| | Moderate | Extreme | Number of | Number of |
|---|---|---|---|---|
| | outlier | outlier | moderate | extreme |
| Group | threshold value | threshold | outlier values | outlier values |
| 1st group | 1.6 | 1.9 | 135 | 0 |
| 2nd group | 1.5 | 1.8 | 0 | 0 |
| 3rd group | 1.6 | 1.9 | 0 | 0 |
| 4th group | 1.55 | 1.7 | 55 | 0 |
| 5th group | 1.65 | 1.8 | 132 | 26 |
| 6th group | 1.75 | 1.9 | 77 | 26 |
| 7th group | 2.00 | 2.3 | 25 | 0 |
| 8th group | 1.85 | 2.0 | 101 | 75 |
| 9th group | 1.85 | 2.0 | 50 | 50 |
| 10th group | 1.95 | 2.1 | 117 | 51 |
| 11th group | 2.05 | 2.2 | 76 | 25 |
| 12th group | 2.2 | 2.5 | 50 | 0 |
| 13th group | 2.2 | 2.5 | 50 | 25 |
| 14th group | 2.15 | 2.3 | 101 | 25 |
| 15th group | 2.4 | 2.7 | 50 | 0 |
| 16th group | 2.25 | 2.4 | 51 | 51 |
| 17th group | 2.5 | 2.8 | 101 | 25 |
| 18th group | 2.35 | 2.5 | 75 | 50 |
| 19th group | 2.5 | 2.8 | 50 | 0 |
| 20th group | 2.43 | 2.65 | 161 | 111 |

As may be seen from Table 1, the processor 204 may determine that a process value meeting the first warning condition occurs in the 4th group to the 20th group by executing the mechanism in the first implementation.

Moreover, the processor 204 may further determine there is a process value meeting the first warning condition in the 5th group, 6th group, 8th group to 11th group, 13th group, 14th group, 16th group to 18th group, and 20th group by executing the mechanism of the second embodiment and/or the third embodiment, but the invention may be not limited thereto.

In the second embodiment, the processor 204 may determine a plurality of second group sets in the N groups, wherein each of the second group sets includes consecutive p groups in the N groups, wherein p is an integer and 1<p≤N. Next, in response to determining that the statistical property variation of each of the groups in any of the second group sets is within a predetermined range, the processor 204 may determine that the statistical property variation corresponding to each of the groups meets the second warning condition. Moreover, in response to determining that the statistical property variation of each of the groups in each of the second group sets is not within the predetermined range, the processor 204 may determine that the statistical property variation corresponding to each of the groups does not meet the second warning condition.

In different implementations of the second embodiment, the p value may adopt different values according to the needs of the designer, so as to derive different determination processes. Description is further provided below.

In the second embodiment, it is assumed that the principle set by the designer is that in all of the groups, if the statistical property variation of 20% or more consecutive groups is within the predetermined range, it is determined that the second warning condition is met. In this case, the processor 204 may obtain, for example, 20% (i.e., 4000) of the total number of process values, and determine p as 4 accordingly, but the invention may be not limited thereto.

After p is determined, the processor 204 may, for example, determine the plurality of second group sets accordingly. In an embodiment, the m-th second group set in the plurality of second group sets may include the m-th group to the (m+p−1)-th group in the N groups, 1≤m≤(N−p+1), but the invention may be not limited thereto. That is, each of the second group sets includes p groups in the N groups, and each of the second group sets has different group members, but the invention may be not limited thereto.

For example, in the case that p is 4 and N is 20, the m-th second group set in the plurality of second group sets may include the m-th group to the (m+p−1)-th group in the N groups, 1≤m≤17, but the invention may be not limited thereto. That is, each of the second group sets includes four groups in the N groups, and each of the second group sets has different group members, but the invention may be not limited thereto.

Accordingly, the processor 204 may determine whether the statistical property of each of the groups in any of the second group sets is within a predetermined range (e.g., between 0.1 and 3). If the statistical property variation of each of the groups in any second group set is within the predetermined range, the processor 204 may determine that the outlier values in the process values meet the second warning condition, and provide a breakage warning accordingly. Moreover, if the statistical property of each of the groups in each of the second group sets is not within the predetermined range (for example, all are less than the lower limit of the predetermined range), the processor 204 may determine that the outlier values in the process values do not meet the second warning condition.

In short, in the case that p is 4 and the first number is 1, if the statistical property variations corresponding to the four consecutive groups are all within the predetermined range, the processor 204 may determine that the second warning condition is met, and provide a corresponding breakage warning, but the invention may be not limited thereto.

As mentioned earlier, the statistical property of each of the groups considered in the second embodiment are, for example, the third quartile corresponding to each of the groups. In this case, when it is determined that the statistical property corresponding to the (j+1)-th group in the N groups is changed, for example, the processor 204 may obtain the difference between the third quartile of the (j+1)-th group and the third quartile of the j-th group in the N groups as the statistical property variation corresponding to the (j+1)-th group.

In an embodiment, the difference between the third quartile of the (j+1)-th group and the third quartile of the j-th group may be characterized, for example, as the absolute value of the slope between the third quartile of the (j+1)-th group and the third quartile of the j-th group.

In an embodiment, the slope corresponding to the (j+1)-th group may be characterized as “|(Q_(j+1)−Q_j)|”, for example, wherein Q_(j+1) is the third quartile of the (j+1)-th group, and Q_j is the third quartile of the j-th group, but the invention may be not limited thereto.

In an embodiment, the slopes and the absolute values thereof of each of the groups in FIG. 6A may be arranged, for example, as the contents of Table 2 below.

TABLE 2

| | | | Absolute value of |
|---|---|---|---|
| Group | Third quartile | Slope | slope |
| 1st group | 1.3 | N/A | N/A |
| 2nd group | 1.2 | −0.1 | 0.1 |
| 3rd group | 1.3 | 0.1 | 0.1 |
| 4th group | 1.4 | 0.1 | 0.1 |
| 5th group | 1.5 | 0.1 | 0.1 |
| 6th group | 1.6 | 0.1 | 0.1 |
| 7th group | 1.7 | 0.1 | 0.1 |
| 8th group | 1.7 | 0 | 0 |
| 9th group | 1.7 | 0 | 0 |
| 10th group | 1.8 | 0.1 | 0.1 |
| 11th group | 1.9 | 0.1 | 0.1 |
| 12th group | 1.9 | 0 | 0 |
| 13th group | 1.9 | 0 | 0 |
| 14th group | 2 | 0.1 | 0.1 |
| 15th group | 2.1 | 0.1 | 0.1 |
| 16th group | 2.1 | 0 | 0 |
| 17th group | 2.2 | 0.1 | 0.1 |
| 18th group | 2.2 | 0 | 0 |
| 19th group | 2.2 | 0 | 0 |
| 20th group | 2.2 | 0 | 0 |

As may be seen from Table 2, the processor 204 may determine that a process value meeting the second warning condition occurs in the 2nd group to the 6th group by executing the mechanism in the second embodiment.

In an embodiment of the invention, the processor 204 may simultaneously execute the determination operations in one or a plurality of a plurality of implementations in the first embodiment and/or the second embodiment. If the processor 204 determines that the process values are determined to meet the first warning condition and/or the second warning condition in any of the various implementations of the first embodiment and the second embodiment, the processor 204 may provide a corresponding breakage warning, but the invention may be not limited thereto.

Moreover, in an embodiment, the processor 204 may not provide a breakage warning associated with the cutting wire 10 in response to determining that the outlier values in the process values do not meet the first warning condition, and the statistical property variation corresponding to each of the groups do not meet the second warning condition.

Based on the above, in an embodiment of the invention, after a plurality of process values (such as the tension values of the cutting wire) are obtained when the crystal ingot cutting machine uses the cutting wire to cut the crystal ingot, these process values may be analyzed to determine the associated outlier values and/or the statistical property variation. Moreover, when it is determined that the outlier values meet the first warning condition and/or the statistical property variation meets the second warning condition, an embodiment of the invention may provide a corresponding breakage warning.

Accordingly, the relevant operators of the crystal ingot cutting machine may take corresponding measures according to the breakage warning (such as adjusting the operating parameters of the crystal ingot cutting machine, replacing the cutting wire, etc.), thus avoiding affecting the cutting effect of the crystal ingot due to accidental breakage of the cutting wire.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A method for providing a wire breakage warning, comprising:
obtaining a plurality of process values when a crystal ingot cutting machine uses a cutting wire to cut a crystal ingot;
dividing the process values into N groups, and determining a statistical property of each of the groups, wherein N in a positive integer;
identifying at least one outlier value in the process values based on the statistical property of each of the groups, or determining a statistical property variation corresponding to each of the groups based on the statistical property of each of the groups; and
providing a wire breakage warning associated with the cutting wire in response to determining that the at least one outlier value in the process values meets a first warning condition, or the statistical property variation corresponding to each of the groups meets a second warning condition.

2. The method of claim 1, wherein the process values comprise a plurality of tension values measured from the cutting wire.

3. The method of claim 1, wherein the groups comprise an i-th group, i is an index value and 1≤i≤N, the statistical property of each of the groups comprises a first quartile and a third quartile of the process values of each of the groups, and the step of identifying the at least one outlier value in the process values based on the statistical property of each of the groups comprises:
determining a first outlier threshold value corresponding to the i-th group based on the first quartile and the third quartile corresponding to the i-th group;
in response to determining that there is at least one in the process values of the i-th group exceeding the first outlier threshold value, determining the at least one as the at least one outlier value corresponding to the i-th group;
in response to determining that none of the process values of the i-th group exceeds the first outlier threshold value, determining that the i-th group does not have the corresponding at least one outlier value.

4. The method of claim 3, wherein the step of determining the first outlier threshold value corresponding to the i-th group based on the first quartile and the third quartile corresponding to the i-th group comprises:
obtaining a difference between the first quartile and the third quartile corresponding to the i-th group, and determining a first factor;
obtaining a first product of the difference and the first factor, and summing the first product with the third quartile corresponding to the i-th group as the first outlier threshold value.

5. The method of claim 4, wherein the first factor is between 0.1 and 2, or between 2 and 5.

6. The method of claim 3, further comprising:
determining a plurality of first group sets in the groups, wherein each of the first group sets comprises consecutive k groups in the groups, wherein k is an integer and 1≤k≤N;
in response to determining that a number sum of the at least one outlier value corresponding to the groups in any of the first group sets is not less than a first number, determining that the at least one outlier value in the process values meets the first warning condition;
in response to determining that the number sum of the at least one outlier value corresponding to the groups in any of the first group sets is less than the first number, determining that the at least one outlier value in the process values does not meet the first warning condition.

7. The method of claim 1, wherein the groups comprise a j-th group and a (j+1)-th group, j is an index value and 1≤j<N, and the step of determining a statistical property variation corresponding to each of the groups based on the statistical property of each of the groups comprises:
obtaining a difference between the statistical property of the (j+1)-th group and the statistical property of the j-th group as the statistical property variation corresponding to the (j+1)-th group.

8. The method of claim 7, further comprising:
determining a plurality of second group sets in the groups, wherein each of the second group sets comprises consecutive p groups in the groups, wherein p is an integer and 1<p≤N;
in response to determining that the statistical property variation of each of the groups in any of the second group sets is within a predetermined range, determining that the statistical property variation corresponding to each of the groups meets the second warning condition;
in response to determining that the statistical property variation of each of the groups in each of the second group sets is not within the predetermined range, determining that the statistical property variation corresponding to each of the groups does not meet the second warning condition.

9. The method of claim 7, wherein the statistical property of each of the groups comprises a third quartile of the process values of each of the groups.

10. The method of claim 1, further comprising:
not providing the wire breakage warning associated with the cutting wire in response to determining that the at least one outlier value in the process values does not meet the first warning condition, and the statistical property variation corresponding to each of the groups does not meet the second warning condition.

11. A device for providing a wire breakage warning, comprising:
a storage circuit storing a program code; and
a processor coupled to the storage circuit and accessing the program code to execute:
obtaining a plurality of process values when a crystal ingot cutting machine uses a cutting wire to cut a crystal ingot;
dividing the process values into N groups, and determining a statistical property of each of the groups, wherein N in a positive integer;
identifying at least one outlier value in the process values based on the statistical property of each of the groups, or determining a statistical property variation corresponding to each of the groups based on the statistical property of each of the groups; and
providing a wire breakage warning associated with the cutting wire in response to determining that the at least one outlier value in the process values meets a first warning condition, or the statistical property variation corresponding to each of the groups meets a second warning condition.
